(19) United States
(12) Patent Application Publication
(10) Pub. No.: US 2021/0042696 A1
(43) Pub. Date: Feb. 11, 2021

(54) METHOD AND SYSTEM FOR ESTIMATING THE ACCUMULATED EXPOSURE OF AN ENTITY

(71) Applicant: TRUENORTH SYSTEMS LTD, Tel Aviv (IL)

(72) Inventors: Shlomo Lahav, Ramat-Gan (IL); Efrat Ben-Ami, Tel Aviv (IL)

(73) Assignee: TRUENORTH SYSTEMS LTD, Tel Aviv (IL)

(21) Appl. No.: 16/945,885

(22) Filed: Aug. 2, 2020

Related U.S. Application Data
(60) Provisional application No. 62/883,187, filed on Aug. 6, 2019.
(60) Provisional application No. 62/892,061, filed on Aug. 27, 2019.

(51) Int. Cl. G06Q 10/08; G06Q 40/08

(52) U.S. Cl. CPC G06Q 10/0835; G06Q 10/0831; G06Q 10/0838; G06Q 40/08

(57) ABSTRACT

The present disclosure describes method and system for estimating the accumulated-exposure of an insurance company. The accumulated-exposure can be estimated per an insured customer, per an insurance event or per period of time. Some example embodiments of the disclosed technique take into consideration the history of the insured customer. Yet, some example embodiments of the disclosed technique take into consideration the frequent of appearance of an insurance event. Some embodiments of the disclosed technique are configured to alert when the accumulated-exposure is greater than a predefined threshold.

### CROSS-REFERENCE TO RELATED APPLICATIONS

This utility patent application being filed in the United States as a non-provisional application for patent under Title 35 U.S.C. § 100 et seq. and 37 C.F.R. § 1.53(b) and, claiming the benefit of the prior filing date under Title 35, U.S.C. § 119(e) of the United States provisional application for patent that was filed on Aug. 6, 2019 and assigned the Ser. No. 62/883,187, which application is herein incorporated by reference in its entirety; and the U.S. provisional application for patent that was filed on Aug. 27, 2019 and assigned the Ser. No. 62/892,061, which application is herein incorporated by reference in its entirety. Further, this utility patent application is related to utility patent applications U.S. Ser. No. 16/658,138; U.S. Ser. No. 16/658,143; and U.S. Ser. No. 16/658,151 that were all filed on Oct. 20, 2019, which applications are herein incorporated by reference in their entirety. Furthermore, this utility patent application is related to utility patent applications U.S. Ser. No. 16/849,195; and U.S. Ser. No. 16/849,952 that were all filed on Apr. 15, 2020, which applications are herein incorporated by reference in their entirety. In addition this utility patent application is related to utility patent application U.S. Ser. No. 16/867,224 that was filed on May 5, 2020, which application are herein incorporated by reference in their entirety. Further, this utility patent application is related to utility patent application U.S. Ser. No. 16/883,385 that was filed on May 26, 2020, which application are herein incorporated by reference in their entirety.

### FIELD OF THE INVENTION

The present disclosure relates to the field of cargo transportation and more particularly to the field of estimating the accumulated exposure of a responsible entity. The responsible entity can be a truck company, a sea carrier, a ship, a port manger, an insurance company, etc. Along the present disclosure and the claims the terms: a truck company, a sea carrier, a train company, a port, an airport, a warehouse, etc. can be used interchangeably and the term carrier can be used for representing those terms.

### BACKGROUND OF THE INVENTION

Common cargo transportation is implemented by a shipping unit. An example of a cargo shipping unit (CSU) can be a container, an air parcel, etc. A common CSU provides an enclosed space in which physical items can be stored during shipment. A single journey of a CSU can comprise a plurality of segments. In each segment a different entity can be responsible for the safety of the CSU and its cargo.

An example of a journey of a CSU from an origin (such as but not limited to a factory, a warehouse, a retail outlet, etc.) to a destination (such as but not limited to a warehouse, a retail outlet, a customer premises, etc.) can comprise a plurality of segments. Segments such as but not limited to: loading the goods into the CSU at the shipper's platform; loading the CSU on a truck or a train at the shipper's yard; transporting the CSU toward the port or the airport; off-loading the CSU from the truck or the train; storing the CSU at the port or airport; embarking the CSU on a ship or an airplane; transporting the CSU by the ship or the airplane; off-loading the CSU from the ship or the airplane; temporary storing the CSU in the port (airport); loading the CSU on a truck or a train; transporting the CSU toward the consignee's yard; and downloading the CSU from the truck to the consignee's platform. Along the disclosure and the claims the terms origin, shipper and supplier can be used interchangeably and the terms destination, consignee, supplier's customer, or customer can be used interchangeably.

A person having ordinary skill in the art of cargo transportation can appreciate that some journeys may comprise all the above segments; other journeys may comprise part of those segments; and some journeys may comprise more segments than the ones that are disclosed above. Yet in some journeys the order of the segments can be other than the above disclosed order. It should be noted that the disclosed segments of a journey are not intended to limit the scope of the inventive concepts in any manner.

There are journeys in which different entities are responsible for the safety of the cargo. Each entity can be responsible for one or more segments of a journey. A truck company can be responsible for losses that occur during traveling by a truck. A sea carrier can be responsible for loading the cargo on the ship, loss that occurs during the ship traveling or when off-loading the CSU from the ship, etc. An insurance company that is responsible to pay for the losses that related to one of those entities, entity which is responsible for the safety of the cargo at a certain segment.

Each one of the responsible entity needs to know the accumulated exposure related to that entity. The entity can be a sea carrier, a truck company, a port manger, a warehouse, etc. Further, the accumulated exposure is time dependent; therefore each one of those entities including an insurance company may monitor its accumulated exposure periodically. Furthermore, an insurance company or any of the carriers may need to be aware to its accumulated exposure in case that an insurance event occurs. An insurance event can be such as but not limited to an earthquake, a sinking ship, a tornado, etc. Along the disclosure and the claims the terms insurance-company, secondary-insurance company, Protection and Indemnity Clubs (P&I Clubs) can be used interchangeably and the term insurance company can be used for representing this group.

In addition, there are cases that several entities purchase an insurance policy for a certain CSU. Those entities can be the customer at the end of the journey; the supplier that delivers the goods; the shipping company, etc. Each one of those entity may purchase an insurance policy for that CSU.

Furthermore, a carrier company, such as but not limited to a shipping company, a train company, etc. may purchase an open-insurance-policy (OIP). The OIP is based on a declaration of the carrier company that the total number of CSUs that the company handles during a period of time is X and the maximum value, per CSU, is Y US$. The period of time that an OIP may cover can be such as but not limited to a week, a month, a year, etc. However, the real exact value and quantity of the goods that are currently covered by an OIP is unknown. Thus, there is a need for a system that can estimate the accumulated exposure of that entity in order to purchase an appropriate OIP.

Thus a person with ordinary skill in the art of transporting CSUs can appreciate that an insurance company or any other responsible entity may face a situation in which their accumulated exposure can be higher than the assets of that entity. In order prevent bankruptcy, due to higher accumulated exposure; an insurance company may purchase a secondary-insurance from another insurance company. The secondary-insurance can protect the insurance company when a disaster occurs. A disaster can be, such as but not limited to, a ship that may sink or an earthquake near to a port, etc. In order to purchase an appropriate secondary-insurance policy the insurance company needs to monitor its accumulated exposure (AcEx).

Furthermore, unknowing the actual value of a cargo that is covered by an OIP may lead to charge a premium that is higher or lower than a premium that reflects the true value of goods. Such a mismatch may lead the insurance company to lose customers due to higher premium or lose money due to smaller premium than the appropriate one.

### SUMMARY OF THE DISCLOSURE

The needs and the deficiencies, which are disclosed above in relation to cargo transportation, are not intended to limit the scope of the inventive concepts of the present disclosure in any manner. The needs are presented for illustration only.

Example embodiments of the present disclosure seek to provide a novel technique for determining the AcEx of a carrier company or an insurance company. The carrier company can be a truck company, a sea carrier, a warehouse, etc. The AcEx can be related to a certain period of time, a certain location, a certain carrier, a certain CSU or any combination of them. An example embodiment of a processing system that can monitor the AcEx of an entity can be referred as AcEx Processing Unit (AcExPU). The entity can be a carrier, a warehouse or an insurance company.

An example embodiment of AcExPU may obtain, from an involved entity, a database of relevant bill-of-ladings (BoL). The BoL that are related to that involved-entity of a certain insurance company. The involved-entity may be a shipping company, a warehouse, a port, etc. The BoL can cover one or more CSUs that are related to a certain customer and are transferred from the same origin to the same destination. Along the present disclosure and the claims the terms involved-entity and insured-customer can be used interchangeably.

The BoL comprise information related to the origin and the destination of the one or more CSUs, information related to the cargo that is associated with the relevant CSUs. The information may comprise the number of units, the content of the CSUs, etc. In addition, the BoL may comprise information related to the journey that the relevant CSUs is intended to do.

Further, a carrier company may deliver indication each time a CSU changes its status. The indication can be obtained from a GPS that is associated with the CSU. Alternatively, information about changing a status of a CSU can be obtained from a routing-event-message. The routing-event-message indicates that the CSU changes its status.

Other types of information can be obtained from a relevant insurance company. The information can be arranged as a list of the customers of that insurance company. An example of such a list can be arranged as a table. Each line in the table can be associated with an insured-customer. The first column can be associated with the name of the insured-customer. The second column can be associated with the maximum insured value per event, the 3^{rd} column can be associated with the maximum insured value per CSU, for example.

An example of AcExPU may be configured to periodically calculate the accumulated exposure of the insurance company per each one of the listed insured-customers. Per each insured-customer a database (DB) of BoLs can be searched looking for BoLs that are related to that insured-customer. Next, the total number of CSUs that are written in the found BoLs can be calculated. The total number of CSUs can be written in the 4^{th} column of the table. Then, an example of AcExPU may multiply the number of related CSUs by the maximum insured value per CSU in order to determine the maximum-insured value and the result can be stored in a 5^{th} column of the list.

Next, the maximum insured value per event and the actual-insured value can be compared by the AcExPU and the smallest value can be defined as the accumulated exposure of the insurance company to that insured-customer. This value can be written in the 6^{th} column of the table.

Then, the AcExPU may proceed to the next insured-customer in the list, which was obtained from the insurance company, in order to define the accumulated exposure of the insurance company to the second insured-customer, and so on. In case that the insured-cargo is involved with two or more insured-customers, then an example embodiment of the disclosed technique may split the liability between the two or more insured-customers. The split can be done evenly or according to the insurance policy of each one of them.

After handling the last insured-customer in the list, an example of AcExPU can be configured to calculate the total accumulated exposure of the insurance company by summing the accumulated exposure of each one of the insured-customers, which is stored in the junction of the 6^{th} column and the line that is allocated to that insured-customer.

In case that a certain BoL does not comprise information about the true value of the goods in a certain CSU, then an example of AcExPU can be configured to estimate the value of the goods based on previous filed one or more “forms that describes a loss” (FTDLs) that are related to similar goods. This estimation can be done based on the goods type (usually referred to as an HS code), the goods origin and the shipper. A machine learning model can be used to estimate the goods value.

Other example embodiment of AcExPU may apply to a commodity market in order to obtain the price of similar goods. Yet, other embodiments of an example AcExPU may be configured to apply or manage a commodity-price-index such as but not limited to Dow-Jones-AIG-Commodity-Index (DJ AIG).

An example of commodity-price-index may be grouped into categories. Following are few examples of categories. Based metal, which may comprise Zink, Nickel, Copper, etc. Other category can be grains, which may comprise the prices of Corn, Rice, Wheat, etc. Yet, another category can be Life-stock that can comprise the price of cattle, pork, etc. Thus, according to the type of the relevant goods, an example of AcExPU may apply to the appropriate category of goods and retrieve its price.

Further, some example embodiments of AcExPU may be configured to consider the history of an insured-customer in order to calculate its accumulated exposure. An example of such embodiment may divide the insured customers into two or more groups according to their history of filing form that describes a loss” (FTDL). A coefficient can be allocated to each group. The coefficient can be multiplied with the accumulated exposure of that insured-customer in order to get its contribution to the accumulated exposure of the insurance company.

In case in which two groups are used, then a first coefficient can be 100% and be assigned to the group of insured-customers that filed high number of FTDLs (risky insured-customers). The other coefficient can be 75% and be assigned to the group of insured-customers that filed few numbers of FTDLs. Other example embodiments of the AcExPU may use other number of groups (three, five, etc.) and may use other values for their coefficient (100%, 90%, 80%. Etc.).

Furthermore, some example embodiments of the novel technique may divide the insurance-events into two or more groups according to their frequency of appearance. A coefficient can be allocated to each group. The coefficient can be multiplied with the accumulated exposure of that insurance-event in order to get its contribution to the accumulated exposure of the insurance company. In case in which two groups are used, then a first coefficient can be 100% and be assigned to the group with high number of appearance, high frequent event. The other coefficient can be 80% and be assigned to the group with few numbers of insurance-events that occurred. Other example embodiments of the AcExPU may use other number of groups (three, five, etc.) and may use other values for their coefficient (100%, 90%, 80%. Etc.).

Some example embodiments of the disclosed technique may take into consideration the journey of a certain CSU. Such example embodiment may divide the different possible routes of a certain journey into two or more groups according to amount of filed FTDLs, which are associated with that route (risky routes and not-risky routes). Risky routes can be routes in area with storms or areas with pirates, etc. A coefficient can be allocated to each group. The coefficient can be multiplied with the accumulated exposure of that insured-customer in order to get its contribution to the accumulated exposure of the insurance company.

Some example embodiment of AcExPU may present a report that comprises a time-dependent-table (TDT). Each line in the TDT can be associated with an insured-customer and the columns can be associated with specific time or with time intervals. Each cell, in the junction between an insured-customer and a certain time, can comprise the value of the accumulated exposure of the insurance company to that insured-customer. The last line can comprise the total value of the accumulated exposure of the insurance company at that time.

Some embodiments of AcExPU can be configured to plot a plurality of graphs. Each graph can be associated with a customer of the insurance company. The X axis can be associated with time and the Y axis can present the accumulated exposure at that time for that insured-customer.

Some example embodiment of AcExPU can be configured to alert each time the accumulated exposure exceed a certain threshold. The alert can be sent to a supervisor desk. Furthermore, some embodiments of the AcExPU can be configured to respond to a request from a supervisor to calculate the accumulated exposure, per a certain customer or for all of the customers, per a certain location, per a certain time or any combination of those.

The foregoing summary is not intended to summarize each potential embodiment or every aspect of the present disclosure. Other features and advantages of the present disclosure will become apparent upon reading the following detailed description of example embodiments with the accompanying drawings and appended claims.

Furthermore, although specific example embodiments are described in detail to illustrate the inventive concepts to a person skilled in the art, such embodiments are subject to various modifications and alternative forms. Accordingly, the figures and written description are not intended to limit the scope of the inventive concepts in any manner.

Other objects, features, and advantages of the present invention will become apparent upon reading the following non-limiting detailed description of the disclosed embodiments with the accompanying drawings and appended claims.

### BRIEF DESCRIPTION OF THE DRAWINGS

Examples of implementations of the present disclosure are described with respect to the following figures in which:

FIG. 1 illustrates a simplified block diagram with relevant elements of an example of an insurance company premises (ICP);

FIG. 2 schematically illustrates a flowchart showing relevant tasks that can be implemented by an example of AcExPU for calculating the accumulated exposure per insured entity (insured-customer);

FIG. 3 schematically illustrates a flowchart showing relevant tasks that can be implemented by an example of AcExPU for calculating the accumulated exposure per insurance-event; and

FIG. 4 schematically illustrates a flowchart showing relevant tasks that can be implemented by an example of AcExPU for calculating the accumulated exposure of an insurance company.

All the figures are schematic, not necessarily to scale, and generally only show parts which are necessary in order to elucidate the invention, wherein other parts may be omitted or merely suggested.

### DETAILED DESCRIPTION OF EXAMPLE EMBODIMENTS OF THE DISCLOSED TECHNIQUE

Turning now to the figures in which like numerals represent like elements throughout the several views, in which example embodiments of the present invention are described. For convenience, only some elements of the same group may be labeled with numerals. The purpose of the drawings is to describe examples of embodiments and not for production purpose. Therefore, features shown in the figures are chosen for convenience and clarity of presentation only. Moreover, the language used in this disclosure has been principally selected for readability and instructional purposes, and may not have been selected to define or limit the inventive subject matter, resort to the claims being necessary to determine such inventive subject matter.

Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

Although some of the following description is written in terms that relate to software or firmware, embodiments may implement the features and functionality described herein in software, firmware, or hardware as desired, including any combination of software, firmware, and hardware.

In the following description, the words “unit,” “element,” “module” and “logical module” may be used interchangeably. Anything designated as a unit or module may be a stand-alone unit or a specialized or integrated module. A unit or a module may be modular or have modular aspects allowing it to be easily removed and replaced with another similar unit or module. Each unit or module may be any one of, or any combination of, software, hardware, and/or firmware, ultimately resulting in one or more processors programmed to execute the functionality ascribed to the unit or module.

Additionally, multiple modules of the same or different types may be implemented by a single processor. Further, each unit or module can be configured to execute two or more processes in parallel or one after the other. Software of a logical module may be embodied on a non-transitory computer readable device such as but not limited to: a read/write hard disc, CDROM, Flash memory, ROM, or other memory or storage device. In order to execute a certain task a software program may be loaded to an appropriate processor as needed. In the present disclosure the terms task, method, and process can be used interchangeably.

Along the present disclosure and the claims few examples of responsible-entities are mentioned. A responsible entity can be a carrier, such as but not limited to: a truck company, a sea carrier, a train company, an airline company, etc. Other responsible entity can be the management of: a warehouse, a port, an airport, a shipper's platform, etc. Alternatively, a responsible-entity can be an insurance-company. Along the present disclosure and the claims the term insurance company may be used as a representative term for a responsible entity.

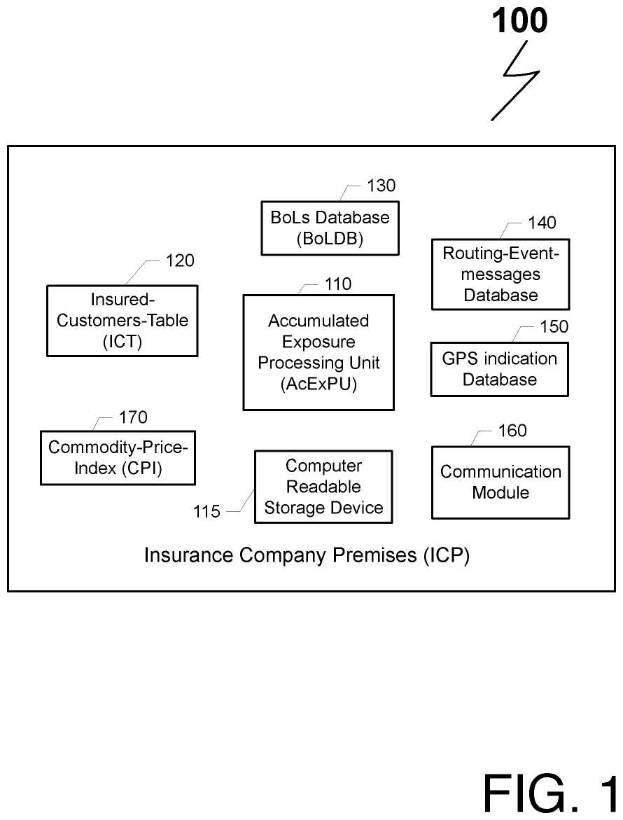

FIG. 1 depicts a simplified block diagram with relevant elements of an example system of an insurance-company premises (ICP) 100 that operates according to the disclosed technique. An example of ICP 100 may comprise an Insured-customer-table (ICT) 120, an AcExPU 110, a computer-readable-storage device 115, a BoL database (BoLDB) 130, a routing event DB 140, a GPS indication DB 150, a communication module 160, and a DB of commodity-price-index 170. In alternate example embodiment in which a carrier is the responsible entity, element 120 can be referred as customer table.

An example of AcExPU 110 can be a high-end computer with powerful Graphical-Processing Unit (GPU) that is configured to execute a plurality of tasks. A non-limiting example of AcExPU 110 can use “Amazon EC2 A1 Instances” or “Amazon EC2 P3 Instances”, which are maintained by Amazon Crop USA. Other embodiments may use “General purpose machine type family N1” which is maintained by Google, USA.

An example of AcExPU 110 can be associated with a non-transitory computer readable storage device 115 that stores a plurality of computer programs to be loaded to the AcExPU 110 according to the task that is currently implemented. An example of computer readable non-transitory storage device 115 can be such as but not limited to a read/write hard disc, CDROM, Flash memory, ROM, or other memory or storage device.

An example of AcExPU 110 can be configured to calculate the accumulated exposure of an insurance company per an insured-customer. The insured-customer can be a carrier company such as but not limited to a sea-carrier, an air-carrier, a train company, a truck company, etc. Another type of an insured-customer can be a warehouse, a port, an air-port, a retail company, a consignee, etc. In case in which the responsible entity is a carrier, the AcExPU 110 can be configured to calculate the accumulated exposure of the carrier company per a certain customer, or a certain vehicle, etc.

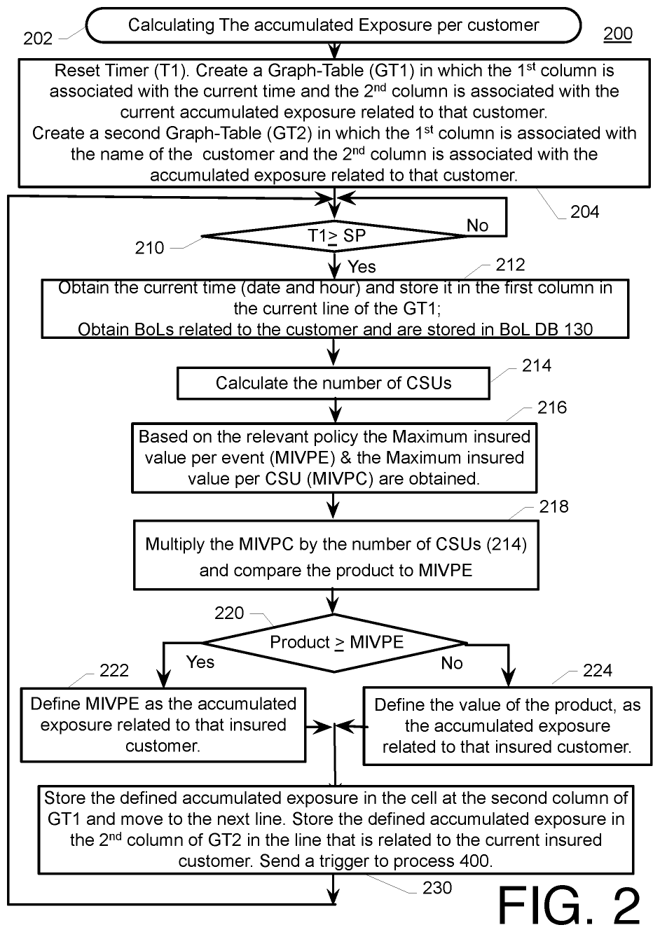

Calculating the accumulated exposure can be implemented periodically, once a day, once a week, etc. Alternatively, the process can be initiated upon obtaining a request from a human manger or from another system to calculate the accumulated exposure per a certain customer. More information about an example process for calculating the accumulated exposure per a customer is disclosed below in conjunction with FIG. 2.

Further, an example of AcExPU 110 can be configured to calculate the accumulated exposure per an event. An event can be such as but not limited to earthquake, a sinking ship, a tornado, etc. Calculating the accumulated exposure per an event can be implemented upon obtaining a request from a human manger and information regarding the event. Then, an example of AcExPU 110 can execute a process for estimating the accumulated exposure per that event. In case that the responsible entity is an insurance company, the event can be an insurance-event that is related to a certain FTDL. In case that the responsible entity is a carrier the event can be a certain delivery of one or more CSUs by one or more vehicles of one or more types of goods, for example.

In order to determine the accumulated exposure per that event an example of the AcExPU 110 may retrieve from the BoLDB 130 the BoL related to its customers. In addition, location information that is related to each BoL can be delivered from the relevant customer and be stored in GPS-indication-DB 150 or in routing-event-DB 140 in a section that is related to the relevant BoL.

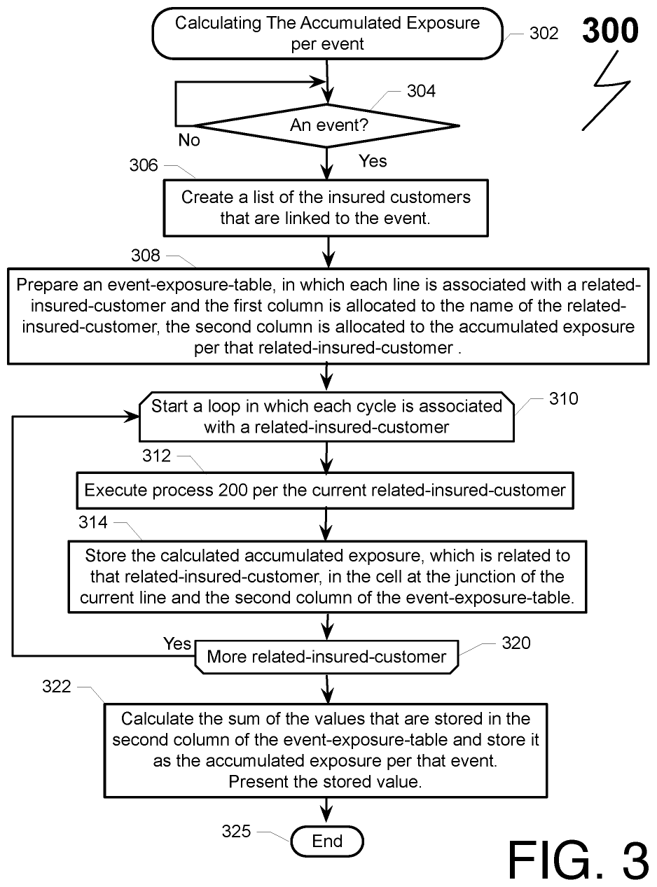

Based on the location information of the CSUs that are related to those BoLs, an example of AcExPU 110 can be configured to estimate the location of the CSUs at the time that the event occurred. CSUs that were located in the same area in which the event occurred could be affected by that event. More information about an example process for calculating the accumulated exposure per an event is disclosed below in conjunction with FIG. 3. The accuracy of associating a CSU to a geographical location may have several levels according to the system that is used to report the location. Reporting based on GPS may have high accuracy. Predicting the location based on routing-event may have low accuracy.

In order to execute some of its tasks an example of AcExPU 110 may manage an Insured-customer-table (ICT) 120. An example of ICT 120 may comprise a plurality of lines and columns. Each line can be associated with an insured-customer. The columns can be associated with insurance data of that customer and data about relevant cargo that is currently handled by that insured-customer.

The first column of an example ICT 120 can comprise identification of the insured customer that is associated with that line. The second column can comprise the maximum insured value per event. The 3^{rd} column can comprise the maximum insured value per CSU. The 4^{th} column can comprise the total number of CSUs that are included in the BoLs that are related to that insured-customer. In the 5^{th} column of an example ICT 120, an example of AcExPU 110 can store the value of the multiplication of the number that is written in the 3^{rd} column (the Max insured value per CSU) by the value that is stored in the 4^{th} column (the number of CSUs) of ICT 120.

In example embodiments in which the responsible entity is a carrier, then order to execute some of its tasks an example of AcExPU 110 may manage a customer-table 120. An example of table 120 may comprise a plurality of lines and columns. Each line can be associated with a customer. The columns can be associated with data related to that customer and data about relevant cargo and vehicles that are currently related to that customer of the carrier.

In case that the responsible entity is a carrier, the first column of an example of table 120 can comprise identification of the customer that is associated with that line. The second column can comprise the maximum value per delivery. The 3^{rd} column can comprise the maximum value per CSU. The 4^{th} column can comprise the total number of CSUs that are included in the BoLs that are related to that customer. In the 5^{th} column of an example of table 120, an example of AcExPU 110 can store the value of the multiplication of the number that is written in the 3^{rd} column (the Max value per CSU) by the value that is stored in the 4^{th} column (the number of CSUs) of ICT 120.

Next, an example of AcExPU 110 can compare between the value that is stored in the cell at the junction of the current line, which is related to the current customer, and the second column, which reflects the maximum insured value per event, with the value that is stored in the junction with the 5^{th} column. The smallest value can be stored in the cell at the junction of the 6^{th} column with the current line. This value may reflect the accumulated exposure of the insurance company per that relevant insured-customer.

Some example embodiments of system 100 may comprise a commodity-Price-Index (CPI) 170. The CPI 170 can be stored in a non-transitory computer readable device such as but not limited to: a read/write hard disc, CDROM, Flash memory, ROM, or other memory device or storage device. The CPI 100 can be arranged as a table in which each line is associated with a commodity and the column is associated with its price. Thus, the value that is stored in a cell that is associated with a certain commodity is the price of a unit of that commodity. The unit depends on the type of the commodity. In case that the cargo is metals, the unit can be tones; in case that the cargo is living animals the units can be the price of a single animal, etc.

In order to manage an example of CPI 170, some example embodiments of AcExPU 110 may be configured to fetch the price per unit of a certain commodity based on filed FTDLs of similar goods. Other example embodiments of AcExPU 110 may apply to a commodity market in order to obtain the price of similar goods. Further other embodiments of an example AcExPU 110 may be configured to use a commodity-price-index such as but not limited to Dow-Jones-AIG-Commodity-Index (DJ AIG), etc.

Some examples of ICT 120 may comprise additional column that may store the index price of the goods that are relevant to the BoLs of that insured-customer. The true value can be fetched from CPI 170. In such an embodiment an example of AcExPU 110 can compare between the value that is stored in the cell at the junction of the current line, which is related to the current insured-customer and the second column, which reflects the maximum insured value per event with the value that reflects the actual price of the cargo. The smallest value can be stored in the cell at the junction of the 6^{th} column with the current line. This value may reflect the accumulated exposure of insurance company related to the relevant insured-customer.

An example of AcExPU 110 can compare between the value that is stored in the cell at the junction of the current line, which is related to the current customer and the second column, which reflects the maximum value per delivery with the value that reflects the actual price of the cargo. The smallest value can be stored in the cell at the junction of the 6^{th} column with the current line. This value may reflect the accumulated exposure of insurance company related to the relevant insured-customer.

In cases that the responsible entity is a carrier, then each line of table 120 can be associated with a customer of the carrier. The columns can be associated with data of that customer and data about relevant cargo that is currently handled by that carrier. The first column of an example table 120 can comprise identification of the customer that is associated with that line. The second column can comprise the value per BoL. The 3^{rd} column can comprise the value per CSU. The 4^{th} column can comprise the total number of CSUs that are included in the BoL that are related to that customer. In the 5^{th} column of an example table 120, an example of AcExPU 110 can store the value of the multiplication of the number that is written in the 3^{rd} column (the value per CSU) by the value that is stored in the 4^{th} column of table 120 (the total number of CSUs). In some embodiments the true value of the cargo can be fetched from CPI 170 and be stored in column 6^{th} of table 120.

An example of AcExPU 110 can compare between the value that is stored in the cell at the junction of the current line, which is related to the current customer and the second column, which reflects the value per BoL with the value that reflects the actual price of the cargo. The smallest value can be stored in the cell at the junction of the 6^{th} column with the current line. This value may reflect the accumulated exposure of a carrier company related to the relevant customer.

Some example embodiments of system 100 can be configured to consider the history of a customer in order to calculate the accumulated exposure per that customer. In such embodiment of ICT 120 two additional columns can be added to ICT 120, column 7^{th} and 8^{th}. The 7^{th} column can be assigned to a group to which the relevant customer belongs based on its history of filing FTDLs. The 8^{th} column can be assigned a coefficient that was allocated to that group of customers.

An example of system 100 may use two groups of customers. The first group may comprise high-risk-customers. A High-risk-customer can be a customer that during a certain period of time filed a certain amount of FTDLs that exceed a certain threshold. The second group may comprise the rest of the customers, regular customer that claimed small number of FTDLs during a certain period of time. An example coefficient for the first group can be 100% while an example coefficient for the second group can be 80%.

An example of AcExPU 110 can be configured to multiply the value of the calculated accumulated exposure related to that customer, which is written in the 6^{th} column, by the appropriate coefficient in order to get a better estimation of the accumulated exposure of the responsible entity. The responsible entity can be an insurance company or a carrier, for example. Other example embodiments of the system 100 may use other number of groups (three, five, etc.) and may use other values for their coefficient (100%, 90%, 80%. Etc.).

Some example embodiments of AcExPU 110 may use two groups of events according to their frequency of appearance. A coefficient can be allocated to each group. The coefficient can be multiplied with the accumulated exposure of that event in order to get its contribution to the accumulated exposure of the responsible entity.

In case in which two groups are used, then a first coefficient can be 100% and be assigned to the group with high number of appearance, high frequent event. The other coefficient can be 80% and be assigned to the group with low frequent event. Other example embodiments of the AcExPU 110 may use other number of groups (three, five, etc.) and may use other values for their coefficient (100%, 90%, 80%, etc.). An event can be such as but not limited to an earthquake, a sinking ship, a tornado, a delivery, a vehicle, etc.

Some embodiments of ICP 100 may comprise a communication module 160. The communication module 160 can be used by AcExPU 110 in order to communicate with an insurance company, a carrier company, with a plurality of customers and with one or more web sites in order to retrieve data that is related to the activity of the AcExPU 110. Web sites that can deliver data related to relevant events, etc. The communication module 160 can be configured to communicate over an Internet-Protocol (IP) network, not shown in the figures. Communication over an IP network is well known to a person having ordinary skill in the art and will not be further disclosed.

Referring now to FIG. 2 that schematically illustrates a flowchart showing relevant tasks of an example process 200. Process 200 can be implemented by an example of AcExPU 110 (FIG. 1) for calculating the accumulated exposure per a customer.

An example of process 200 can be initiated 202 upon initiating the AcExPU 110 and may run periodically every sampling period (SP). The value of a SP can be in the range of few hours to few days, one to ten days, for example, depending on the type of the customer. An example value of SP can be one day.

Some example embodiments of AcExPU 110 may execute a plurality of processes 200 in parallel, one per each customer. Other embodiments of AcExPU 110 may be configured to execute a plurality of processes 200 in serial, per one customer after the other.

At block 204 an example of process 200 may allocate and set elements that may be needed for executing process 200. Timer T1, which is used to define the SP, can be reset; memory space, in the non-transitory computer-readable storage device 115 (FIG. 1), can be allocated for storing a graph-table (GT1) per each customer. The first column of GT1 can be assigned to store the time of the relevant SP. The second column can be allocated to store the value of the accumulated-exposure per that customer at the time of the relevant SP.

Some example embodiments of process 200 may allocate 204 non-transitory memory spaces for storing a second graph-table (GT2). GT2 can be used for storing the accumulated-exposure of all the customers along a plurality of SP. The first column of GT2 can be assigned to store the identification (name) of an customer. The following plurality of columns can be associated with the SPs. Each column can be assign to one SP. The cells in a junction of a certain line and column can store the accumulated exposure per that customer (related to the line) during the SP that is related to the column.

Next, a decision is made 210 whether the value of T1 is equal or greater than the value of the SP. If 210 no, then process 200 may wait until the value of T1 is equal or greater than the value of SP. If 210 yes, then process 200 may proceed to block 212 and may obtain the current time (the date, the hour and the minutes) and stores it in the cell which is in the junction of the current line of GT1 and the first column of GT1. Then, AcExPU 110 may search the BoLDB 130 (FIG. 1) looking for the BoLs that are related to that customer.

At block 214 process 200 may calculated the total number of CSUs that are mentioned in the found BoLs, which are related to that customer. After calculating the total number of CSUs, the insurance policy of that insured-customer is retrieved 216 and the “Maximum insured value per event (MIVPE) & the Maximum insured value per CSU (MIVPC)” are retrieved. In case that process 200 is implemented by a carrier, then at block 214 process 200 may fetch the total number of CSUs, the weight of each CSU, the price of each CSU, etc.

Next, at block 218 the value of MIVPC is multiplied by the number of CSUs that are currently related to the relevant insured-customer. The result of the multiplication (the product) is compared 220 to the value of MIVPE. If 220 the product is bigger than the value of MIVPE, then the value of MIVPE is defined 222 as the accumulated exposure of the insurance company related to the relevant insured-customer. If 220 the product is smaller than the value of MIVPE, then the value of product is defined 224 as the accumulated exposure of the insurance company related to the current insured-customer.

In case that process 200 is implemented by a carrier, then at process 200 can be modified to skip blocks 216 up to 224 and move directly from block 214 to block 230, in which process 200 may store the value that was obtained at block 214 as the accumulated exposure of the carrier related to that customer.

Some example embodiments of process 200 may use the real price of the commodity that is carried by the relevant CSUs in order to calculate the value of MIVPC, which is used in the multiplication at block 218. Fetching the right price of the commodity is disclosed above in conjunction with the description of the operation of AcExPU 110 (FIG. 1).

Furthermore, some example embodiments of process 200 may consider the history of the relevant insured-customer. The history can reflect the quality of the vehicles that are used by the relevant insured-customer; the quality of the staff that is used; the routes in which the relevant insured-customer travels; the number of FTDLs that were field by the relevant insured-customer, etc. Thus, the insured customers can be divided into high-risk-insured-customers and low-risk-insured-customers. Accordingly a coefficient can be allocated to each group. An example coefficient that can be allocated to a high-risk-customer can be 100% while an example coefficient that can be allocated to a low-risk-insured-customer can be 80%. As it is disclosed above in conjunction with the description of the operation of AcExPU 110 (FIG. 1).

FIG. 2 illustrates an example embodiment of process 200 that considers the history of the relevant insured-customer may use the coefficient in order to multiply the value of the product that is obtained in block 218 and be used in block 220. Thus, the defined accumulated-exposure due to a low-risk-insured-customer is reduced compare to a high-risk-customer.

At block 230 the defined accumulated-exposure is stored in table GT1 in the cell at the junction of the current SP and the second column that is assigned to the defined accumulated-exposure due to that customer at that SP. In addition, the value of the defined accumulated-exposure can be stored in GT2 in the cell at the junction of the line that is allocated to that customer and the column that is allocated to the time of the current SP. Then a trigger is sent to activate a cycle of process 400 (block 410) for calculating the accumulated exposure of the insurance company. Alternatively process 400 can be implemented for calculating the accumulated exposure of the carrier company. In some embodiments the trigger can be associated with the time (date, hour, and minutes) of that SP. Next, process 200 returns to block 210 waiting for the next SP.

FIG. 3 schematically illustrates a flowchart showing relevant tasks of an example process 300. Process 300 can be implemented by an example of AcExPU 110 (FIG. 1) for calculating the accumulated exposure of an insurance company per an insurance event. An insurance event can be such as but not limited to an earthquake, a sinking ship, a tornado, etc. Alternatively, process 300 may be implemented by AcExPU 110 per a carrier request for calculating the accumulated exposure of the carrier per one of its customers.

Process 300 can be initiated 302 upon receiving a request from a supervisor, who wishes to know the accumulated exposure of the insurance company per an insurance-event that have been already occurred. Alternatively, process 300 may be initiated 302 in order to verify what will be the accumulated exposure of the insurance company if an insurance event will occur. For example, what will be the accumulated-exposure if an earthquake will occur in Los-Angeles (LA) area during the next week, etc. Alternatively, process 300 can be initiated 302 upon receiving a request from a supervisor of the relevant carrier who wishes to know the accumulated exposure of the of the carrier per one of its customers.

After initiation 302, process 300 may wait 304 to get information about an insurance-event. Based on the obtained information about the insurance-event, process 300 may make 306 a list of related-insured-customers that are linked to the insurance-event. The related-insured-customers can be elected based on location information that is obtained from GPS devices, which are associated with insured CSUs. Wherein the location information indicates that those CSUs were in the area or close to the area in which the insurance-event occurred.

In case that process 300 is implemented in a carrier premises, then at block 306 process 300 may make 306 a list of all the vehicles that belongs to the relevant carrier.

In addition, process 300 may check 306 the Routing-Event-Messages-DB 140 (FIG. 1) in order to determine whether the location of a CSU, which does not have a GPS, is near the area in which the insurance-event occurred. Accordingly AcExPU 110 (FIG. 1) can determine whether to add 306 the insured-customer that is associated to that CSUs to the list of related-insured-customers or not.

Next, at block 308 an event-exposure-table can be prepared. The first column of the event-exposure-table can be assigned to the name (identification) of a related-insured-customer. The second column can be assigned to the accumulated-exposure of the insurance company per the related-insured-customer. Thus, each line in the event-exposure-table can be associated with a related-insured-customer and the cell in the junction of a certain line and the second column is assigned to the accumulated exposure of the insurance company per that related-insured-customer in that insurance-event.

In case that process 300 is implemented by a carrier, then at block 308 an exposure-table per vehicle can be prepared. The first column of the exposure-table can be assigned to the name (identification) of a vehicle. The second column can be assigned to the accumulated-exposure of the carrier per that vehicle. Thus, each line in the event-exposure-table can be associated with a related vehicle and the cell in the junction of a certain line and the second column is assigned to the accumulated exposure of the carrier company per that vehicle in that event.

After preparing 308 the event-exposure-table, a loop can be initiated 310. Each cycle in the loop can be associated with a related-insured-customer that is in the event-exposure-table. At block 312 AcExPU 110 (FIG. 1) can execute a portion of process 200 per the current related-insured-customer. The executed portion may comprise, the second part of block 212, blocks 214 to 224. The defined accumulated exposure related to that insured customer can be stored 314 in the event-exposure-table in the appropriate cell. The cell at the junction of the line assigned to the current related-insured-customer and the second column that is assigned to the accumulated-exposure.

Next, a decision is made 320 whether there is additional related-insured-customer. If 320, yes then process 300 returns to block 310 and start a new cycle per a next related-insured-customer in the list. If 320, there are no additional related-insured-customers in the list, then process 300 proceed to block 322. At block 322 the sum of the values that are written in the second column of the event-exposure-table can be calculated and be stored as the accumulated-exposure-per that event. The stored value can be presented to the supervisor that initiated the process. Then, process 300 can be terminated 325.

Some examples of process 300 may take into consideration the frequency of appearance of a certain insurance-event. In such embodiment a coefficient can be allocated per a certain insurance-event. The accumulated exposure per that event, which was calculated in block 322, can be multiplied by the coefficient in order to obtain a value that reflects the frequency of appearance. An example coefficient for an earthquake in LA can be 100%, while an example coefficient for an earthquake in New-York can be 30%. Other embodiments of process 300 may use other values and other type of insurance events.

In case that process 300 is implemented by a carrier, then after preparing 308 the event-exposure-table, a loop can be initiated 310. Each cycle in the loop can be associated with a vehicle of that carrier. At block 312 AcExPU 110 (FIG. 1) can calculate the exposure per the current vehicle. The defined accumulated exposure related to the current vehicle can be stored 314 in the exposure-table in the appropriate cell. The cell at the junction of the line assigned to the current vehicle and the second column that is assigned to the accumulated-exposure.

Along the disclosure and the claims the term store and write can be used interchangeably. The supervisor can be a human supervisor or a supervising machine.

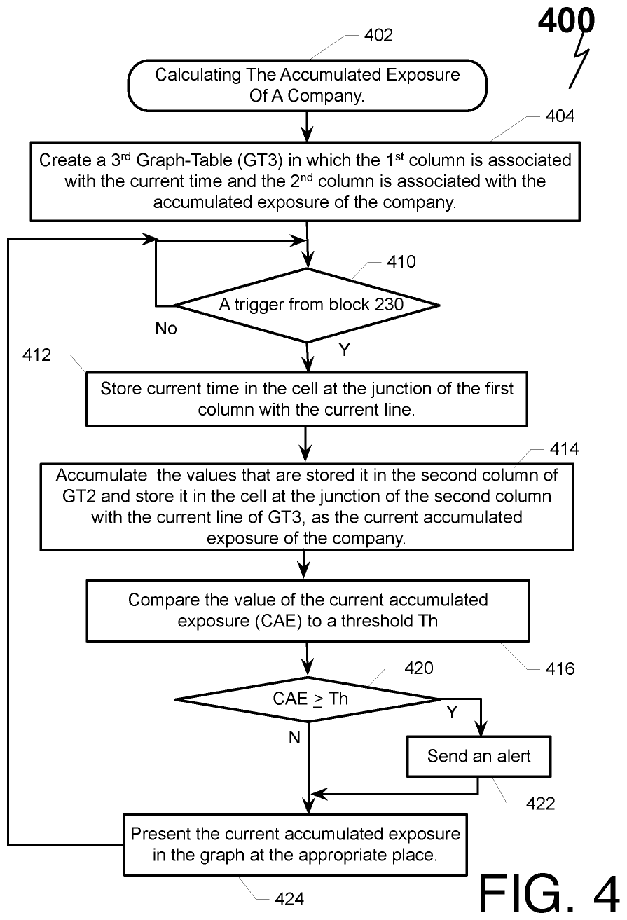

Referring now to FIG. 4 that schematically illustrates a flowchart showing relevant tasks of an example process 400. Process 400 can be implemented by an example of AcExPU 110 (FIG. 1) for calculating the accumulated exposure of an insurance company. A person with ordinary skill in the art of cargo transportation can appreciate that with minor modification Process 400 can be implemented by an example of AcExPU 110 (FIG. 1) for calculating the accumulated exposure of a carrier company.

Upon initiation 402, process 400 may allocate non-transitory memory resources for a 3^{rd} graph-table (GT3). GT3 may comprise two columns and a plurality of lines. Along the present disclosure and the claims the terms: line, row, and record can be used interchangeably.

The first column of GT3 can be assigned to store the time in which the accumulated exposure was calculated. The second column can be allocated to store the value of the accumulated-exposure of the insurance company, or the carrier company, at that time. Next, process 400 may wait 410 to obtain a trigger from block 230 of process 200. The trigger indicates that the accumulated exposure per insured customer, at that time is ready. In case that the company is a carrier, then the trigger indicates that the accumulated exposure per one of the vehicle of that carrier at that time is ready.

Upon receiving 410 a trigger and an indication about the time, in which the calculated accumulated exposure was calculated. The obtain time can be stored 412 in the cell at the junction of the first column of GT3 with the current line. Then, the values that are stored in the second column of GT2 may be accumulated 414 in order to determine the total accumulated exposure of the insurance company per that time and per all insured-customers. The total value can be referred as the current-accumulated-exposure (CAE) of the insurance company. The CAE can be stored 414 in the cell at the junction of the current line of GT3 and the second column.

In case that the company is a carrier company, then the sum of the values that are stored in the second column of GT2 reflects the total accumulated exposure of the carrier company per that time and per all its vehicles.

Next, at block 416 the value of the CAE is compared to a predefine threshold (Th). The threshold can be obtained from the company and may reflect a certain accumulated-exposure above which the management of the company needs to be aware of. At block 420 a decision is made whether CAE is equal or greater than the value of the threshold. If 420 CAE is equal or greater, then an alert can be send 422 to a supervisor desk and process 400 proceed to block 424 for presenting the CAE in a graph at the appropriate location (time and value).

If 420 the value of CAE is not greater than the value of the threshold, then process 400 proceed to block 424. After presenting 424 the CAE process 400 may return to block 410 and waits to the next trigger.

In the description and claims of the present disclosure, each of the verbs, “comprise”, “include” and “have”, and conjugates thereof, are used to indicate that the object or objects of the verb are not necessarily a complete listing of members, components, elements, or parts of the subject or subjects of the verb.

The present invention has been described using detailed descriptions of embodiments that are provided by way of example and do not intended to limit the scope of the invention. The described embodiments comprise different features, not all of which are required in all embodiments of the invention. Some embodiments of the present invention utilize only some of the features or possible combinations of the features. Many other ramification and variations are possible within the teaching of the embodiments comprising different combinations of features noted in the described embodiments.

It will be appreciated by persons having ordinary skill in the art that the present invention is not limited by what has been particularly shown and described herein above. Rather the scope of the invention is defined by the claims that follow.

What is claimed is:

1. A method comprising:
a. employing an accumulated-exposure-Processing-Unit (AcExPU) that is communicatively coupled with one or more databases (DBs);
b. wherein the AcExPU comprises a processor that is configured:
i. to obtain information related to insurance policy of a plurality of insured-customers of an insurance company;
ii. to process the obtained information for estimating the accumulated-exposure of the insurance company; and
iii. to report the estimated accumulated-exposure of the insurance company.

2. The method of claim 1, wherein the AcExPU is further configured to estimate the accumulated-exposure of the insurance company per an insured-customer.

3. The method of claim 2, wherein the insured-customer is a sea-carrier.

4. The method of claim 2, wherein the AcExPU is further configured to estimate the accumulated-exposure of the insurance company per the insured-customer based on the history of the insured-customer.

5. The method of claim 1, wherein the AcExPU is further configured to estimate the accumulated-exposure of the insurance company per an insurance event.

6. The method of claim 5, wherein the insurance event is an earthquake.

7. The method of claim 5, wherein the insurance event has already occurred.

8. The method of claim 7, wherein the AcExPU is further configured to estimate which cargo was associated with the insurance event.

9. The method of claim 5, wherein the AcExPU is further configured to estimate the accumulated-exposure of the insurance company per an insurance event that might occur.

10. The method of claim 9, wherein AcExPU is further configured to estimate the accumulated-exposure of the insurance company per an insurance event, which might occur, takes into consideration the frequency of appearance of similar insurance events.

11. The method of claim 1, wherein the AcExPU is further configured to activate an alert upon determining that the accumulated exposure of the insurance company exceeds a certain threshold.

12. A system comprising:
a. an insured-customer-table (ICT) that is stored in a non-transitory computer-readable-storage device and contains information about the insurance policy of each insured-customer;
b. a bill-of-ladings database (BoLDB) that is stored in a non-transitory computer-readable-storage device and contains information related to insured cargo-shipping-units (CSUs) of each insured-customer;
c. one or more databases that comprise location information of each one of the insured CSUs;
d. an accumulated-exposure-processing-unit (AcExPU), wherein the AcExPU comprises a processor that is configured to estimate the accumulated exposure of an insurance company.

13. The system of claim 12, wherein the AcExPU is further configured to estimate the accumulated-exposure of the insurance company per an insured-customer.

14. The system of claim 13, wherein the insured-customer is a sea-carrier.

15. The system of claim 13, wherein the AcExPU is further configured to estimate the accumulated-exposure of the insurance company per the insured-customer based on the history of the insured-customer

16. The system of claim 12, wherein the AcExPU is further configured to estimate the accumulated-exposure of the insurance company per an insurance event.

17. The system of claim 16, wherein the insurance event is an earthquake.

18. The system of claim 16, wherein the insurance event has been already occurred.

19. The system of claim 16, wherein the AcExPU is further configured to estimate which cargo was involved in the insurance event.

20. The system of claim 16, wherein the AcExPU is further configured to estimate the accumulated-exposure of the insurance company per an insurance event, which may occur, takes into consideration the frequency of appearance of similar insurance events.

21. The system of claim 18, wherein the AcExPU is further configured to estimate the accumulated-exposure of the insurance company per a period of time.
